(19) United States
(12) Patent Application Publication
(10) Pub. No.: US 2009/0087253 A1
(43) Pub. Date: Apr. 2, 2009

(54) BALL AND SOCKET JOINT WITH SENSOR DEVICE, PROCESS FOR LOAD MEASUREMENT AND PROCESS FOR WEAR MEASUREMENT

(76) Inventors: Joachim Spratte, Osnabruck (DE); Michael Klank, Osnabruck (DE); Peter Hofmann, Gauting (DE)

Correspondence Address: MCGLEW & TUTTLE, PC, P.O. BOX 9227, SCARBOROUGH STATION, SCARBOROUGH, NY, 10510-9227, US

(21) Appl. No.: 11/994,185

(22) PCT Filed: Jun. 26, 2006
(86) PCT No.: PCT/DE06/01098

§ 371 Date: Jun. 5, 2008

(30) Foreign Application Priority Data
Jun. 30, 2005 (DE) 10 2005 030 971.2

(51) Int. Cl. F16C 11/06; G01L 5/00

(52) U.S. Cl. 403/131; 701/30

(57) ABSTRACT

A ball and socket joint, a processes for load measurement and for wear measurement is provided, for example, for an axle system of a motor vehicle. The ball and socket joint has a housing (1), in the essentially cylindrical interior space of which a ball shell (2) is arranged. The ball (3) of a ball pivot is slidingly accommodated in the ball shell (2). The ball and socket joint has a sensor device for measuring forces or loads formed by a sensor array (4), which is placed in the area of the ball shell (2) and comprises at least two pressure or force sensors (6) for measuring forces or pressing pressures acting between the joint ball (1) and the ball shell (2). The processes provides permanent monitoring of the operating state and the state of wear of the ball and socket joint, by measuring the prestressing force of the ball shell.

### CROSS REFERENCE TO RELATED APPLICATIONS

This application is a United States National Phase application of International Application PCT/DE 2006/001098 and claims the benefit of priority under 35 U.S.C. § 119 of German Patent Application DE 10 2005 030 971.2 filed Jun. 30, 2005, the entire contents of which are incorporated herein by reference.

### FIELD OF THE INVENTION

The present invention pertains to a ball and socket joint with sensor means, for example, for an axle system or a wheel suspension of a motor vehicle. Furthermore, the present invention pertains to a process for load measurement on a ball and socket joint as well as to a process for wear measurement on a ball and socket joint.

### BACKGROUND OF THE INVENTION

Ball and socket joints of the type mentioned in the introduction are used, for example, but by no means exclusively, on the chassis or on the wheel suspension of motor vehicles, e.g., as a support joint or guide joint. Ball and socket joints of this class comprise a sensor means, with which forces and loads acting on the ball and socket joint can be determined or measured to a certain extent.

Ball and socket joints of this type with means for measuring forces and loads are used, for example, on the motor vehicle in order to reliably determine there the forces or bending torques acting on the ball and socket joint during actual driving or also during test driving on the test bench. Such measurements of forces on ball and socket joints in the area of the chassis of a motor vehicle make it possible to infer the dynamic state of a motor vehicle. It is thus possible to achieve, for example, an improvement of the data base for driving safety systems, for example, ESP or ABS. The ball and socket joints of this class can thus be used especially in the sense of improving the driving safety of the motor vehicle.

A ball and socket joint with force sensor means is known, for example, from DE 101 07 279 A1. The ball and socket joint known from this document is used especially to determine and analyze the force acting in a certain component of a motor vehicle, for example, the axial force present in a track rod because of forces of reaction from the chassis. According to the teaching of this document, provisions are made for this purpose, among other things, for providing a ball and socket joint arranged between different components of the steering linkage with wire strain gauges or piezo pressure sensors in the area of a shaft and for inferring the load on the ball and socket joint and hence the axial forces acting in the steering linkage from the signals of these sensors.

However, the outfitting of ball and socket joints with such wire strain gauges or piezo sensors arranged in the shaft area is associated with a rather substantial effort. On the one hand, a corresponding surface must be created on the ball pivot for the arrangement, on which the wire strain gauges are then, e.g., to be bonded. In addition, an electric wire connection must also be established in the interior of the ball pivot to an electronic analysis unit, and the electronic analysis unit must be arranged, usually separately from the ball and socket joint in case of sensor elements arranged on the ball pivot, additionally in a protected manner at a suitable site. On the whole, this leads to the rather complicated and hence expensive manufacture of such ball and socket joints provided with load sensors. and, moreover, the exposed sensor system and wiring of such ball and socket joints, arranged at an exposed site, are sensitive and therefore threatened by failures.

The benefit of the prior-art ball and socket joints with force sensor means is, moreover, limited. Thus, essentially only a force acting in a certain direction can be determined with the prior-art force sensor means. The prior-art ball and socket joints with force sensor means are thus unsuitable for the comprehensive vectorial determination of forces and/or torques, which act on ball and socket joints and on components connected thereto.

In addition, it is hardly possible in the prior-art ball and socket joints with force sensor means to derive further data on the state especially of the ball and socket joint by means of the force sensor means, beyond the load situation of the ball and socket joint proper. However, since ball and socket joints arranged in the area of the chassis or the steering of motor vehicles are safety-relevant components, whose failure may lead to fatal consequences, especially during driving, it is especially desirable to be also able to obtain data on the instantaneous operating state or state of wear of the ball and socket joint.

### SUMMARY OF THE INVENTION

Against this background, it is the object of the present invention to provide a ball and socket joint with a sensor means, with which ball and socket joint the drawbacks of the state of the art can be overcome. In particular, the ball and socket joint shall make possible the vectorial determination of forces or of loads acting on the ball and socket joint in terms of value and direction in a cost-effective and reliable manner as well as with a high degree of freedom in terms of design. In addition, it shall also be possible to obtain data on the state of wear of the ball and socket joint, so that a possibly imminent failure of a ball and socket joint can be recognized in time and thus prevented.

This object is accomplished by a ball and socket joint having the features according to the invention. The ball and socket joint according to the present invention comprises, on the one hand, in a manner known per se, a joint housing with a mostly essentially cylindrical interior space, in which the ball shell of the ball and socket joint is in turn arranged. The joint ball of the ball and socket joint is accommodated in the ball shell in a slidingly movable manner. In a likewise known manner, the ball and socket joint comprises, furthermore, a sensor means for measuring forces or loads of the ball and socket joint. However, the ball and socket joint is characterized according to the present invention in that the sensor means is formed by a sensor array, which comprises at least two pressure and force sensors and is placed in the area of the ball shell. The sensors are used to measure the forces or pressing pressures acting between the joint ball and the ball shell.

This leads to the substantial advantage that, contrary to the state of the art, the entire sensor means is arranged well protected within the joint housing and is rigidly connected to the joint housing or to the ball shell. This already leads to a both robust and reliable and inexpensive construction of the ball and socket joint according to the present invention.

Unlike in the state of the art, a complicated separate arrangement of the sensor system and the electronic analysis unit with a wiring that may be needed between them through the hollow ball pivot is no longer necessary, but both the sensor system and the electronic analysis unit can rather be arranged together within the joint housing and connected to one another. Even an arrangement of both the sensors and the electronic analysis unit on one and the same common flexible printed circuit board is conceivable and provided. Any mechanical changes on the ball pivot or on the joint ball, by which the stability of the ball and socket joint could be compromised, are no longer necessary, either. The costs that have been associated therewith so far can also be eliminated.

The arrangement according to the present invention of at least two pressure sensors in the area of the ball shell means in other words that the at least two sensors together with the center of the ball define an at least two-dimensional system of coordinates. Force and pressure signals for at least two different directions in space can thus be determined with the sensors, and the resulting vectorial force that instantaneously acts on the ball and socket joint can in turn be determined from these [signals] by means of a suitable vectorial addition in terms of value and direction in the at least two-dimensional system of coordinates.

Finally, besides forces, which act on the ball and socket joint from the outside, data on internal forces of the ball and socket joint can additionally also be obtained thanks to the principle of measurement according to the present invention. One can think in this connection, in particular, of the detection of the prestressing force of the ball shell, whose value, decreasing over time, can be used as an indicator of the increasing wear on the ball and socket joint.

How exactly the at least two sensors of the ball and socket joint are arranged in space is at first irrelevant for the embodiment of the present invention as long as they define, together with the center of the ball, an at least two-dimensional system of coordinates.

However, provisions are made according to a preferred embodiment of the present invention for the sensor means to be formed by a sensor array comprising the pressure or force sensors, which is placed in the area of the ball shell. The sensors are again used to measure the forces or pressing pressures acting between the joint ball and the ball shell. The three sensors are arranged essentially on an imaginary sensor spherical surface that is concentric to the joint ball such that the plane spanned by the three sensors does not pass through the center of the sensor spherical surface or the joint ball.

In other words, this means that the three sensors surround the joint ball or the ball shell essentially on an imaginary spherical surface, and the sensors define, together with the center of the ball, a three-dimensional system of coordinates. Force and pressure signals for three different directions in space can thus be determined with the sensors, and the resulting total vectorial force, which instantaneously acts on the ball and socket joint, can in turn be determined from these signals by means of vectorial addition. Complete vectorial determination of the forces acting instantaneously on the ball and socket joint is thus possible in the three-dimensional space.

According to another, especially preferred embodiment of the present invention, the sensor array comprises eight sensors, which are arranged on at least two mutually different great circles of the imaginary sensor spherical surface. The eight sensors are preferably arranged at the corner points of an imaginary square column inscribed in the sensor spherical surface, i.e., a cuboid with a square base, the vertical axis of the square column coinciding with the longitudinal axis of the ball pivot.

In other words, this means that the joint ball is surrounded by an array of eight sensors, which is positioned symmetrically in relation to the ball pivot and concentrically to the joint ball.

The increased number of sensors leads to an increase in the accuracy of measurement and to minimization of inevitable measuring inaccuracies. Furthermore, the symmetrical arrangement of the eight sensors, which preferably coincides with a rectangular Cartesian system of coordinates, makes possible a uniform measuring accuracy practically independently from the direction of action of the load acting in the ball and socket joint, and it facilitates, moreover, the analysis of the measured signals of the individual sensors as well as the conversion of these signals into the resulting total vectorial force in the Cartesian system of coordinates.

In addition, such an array comprising eight sensors permits the reliable determination of the force actually acting on the ball and socket joint even under difficult conditions. Thus, it is imaginable, for example, that the force acting on the ball and socket joint is so strong that the internal prestressing force within the joint is completely overcome, so that the joint ball is lifted off from the ball shell on the side opposite the direction of the force. Reliable determination of the force acting on the ball and socket joint in terms of value and direction in the three-dimensional space is guaranteed in such a case only if the force acting on the ball and socket joint still also acts on at least three sensors not located on the same great circle even in the state of the joint ball in which it is partially lifted off from the ball shell.

However, if eight sensors are used in the array described, it is guaranteed that the joint ball is not lifted off from the ball shell in all imaginable loading cases in the area of at least four of the eight sensors. The total vectorial force can thus be reliably determined for every imaginable loading case of the ball and socket joint.

The present invention is embodied independently from the design of the sensors or the principle of action according to which the sensors operate, as long as the sensors used are suitable for measuring the foreseeably occurring forces or surface pressures. According to preferred embodiments of the present invention, the sensors are designed, however, as wire strain gauges or as piezo sensors. This has the advantage that commercially available and inexpensive sensors can be used.

Provisions are made, by contrast, according to another, especially preferred embodiment of the present invention, for the sensors to be designed in the form of capacitive sensors. Each of the capacitive sensors preferably now comprises an electrode arranged on the outer side of the ball shell or within the wall of the ball shell, the counterelectrode of the capacitive sensor being formed by the joint ball itself in this case.

The use of capacitive sensors of such a design is especially advantageous in terms of a simple and robust design and trouble-free operation of the ball and socket joint according to the present invention. The principle of action of the capacitive sensor is that a capacitor, whose capacitance changes with any change in the distance between the electrode and the joint ball, is formed by the electrode arranged in the area of the ball shell, together with the joint ball electrically insulated from that electrode by the material of the ball shell.

Since the elastic changes in the wall thickness of the ball shell are proportional to the surface pressure acting between the joint ball and the ball shell within broad ranges, the locally instantaneously prevailing surface pressure can be inferred directly and extremely accurately by means of registration of the change in the capacitance of the particular capacitive sensor.

Further advantages of capacitive sensors are that they operate permanently practically completely without wear, have a simple analysis circuit and require, moreover, only a minimum operating current.

Provisions are made in this connection according to another embodiment of the present invention for each of the capacitive sensors to comprise two series-connected capacitors. The two capacitors connected in series are formed by two electrodes arranged adjacent to one another on the outer side of the ball shell or within the wall of the ball shell, together with the joint ball, which is free from potential in this case, as the intermediate electrode common to both capacitors.

This embodiment has the additional decisive advantage that electrical contacting of the joint ball is no longer necessary here. It is rather sufficient to establish an electrically conductive connection between the two electrodes of the capacitive sensor, which are arranged adjacent to one another, and the corresponding analysis circuit, and to monitor the capacitance between the two electrodes arranged adjacent to one another.

To determine the force acting on the ball and socket joint, the measured force and pressure signals of the sensors of the ball and socket joint are registered in a first process step. The prevailing local forces, pressures and surface pressures are subsequently determined in another process step on the basis of the measured signals of the sensors. The force vector resulting from the local forces, pressures and surface pressures is subsequently determined in the Cartesian system of coordinates in another process step.

The process according to the present invention has the advantage that the force acting on the ball and socket joint can be detected and measured not only in terms of its value but also in terms of its direction in the three-dimensional space. The measurement of forces on the ball and socket joint in terms of both the value of the force and in terms of the direction of the force with a sensor means that is accommodated entirely in the joint housing and is therefore reliable and robust yields an excellent data base in a simple and reliable manner, for example, in the testing operation, or for driving safety and driver assistance systems of a motor vehicle, for example, for ABS and ESP, but also for advanced vehicle systems, for example, X-by-wire technologies.

According to a preferred embodiment of the process for load measurement according to the present invention, a prestressing force between the ball shell and the joint ball is also determined as an alternative or in addition to the determination of the force vector acting on the ball and socket joint within the framework of the calculation of the resultant from the sensor signals.

The calculation of the prestressing force between the ball shell and the joint ball is carried out preferably by means of forming the sum of the signals of sensors of the ball and socket joint that are located opposite each other. The prestressing force can be reliably derived in this manner even in the presence of additional external forces, which may also be variable.

The determination of the prestressing force in the ball shell of a ball and socket joint is especially advantageous because the value of the prestressing force, which decreases over time, can be used especially as an indicator of the progressive wear of the ball and socket joint, because the ball shell of a ball and socket joint is made usually of a viscoplastic polymer and is subject to both superficial wear because of the relative motion between the ball surface and the ball shell and to a certain relaxation based on creeping motions of the plastic during the service life of the ball and socket joint. Both contribute to the fact that the prestress in the ball and socket joint declines over time, as a result of which the clearance of the joint may also increase, especially under load.

The value of the prestressing force, which decreases over time, can therefore be used as an indicator of the instantaneous state and the still remaining service life of a ball and socket joint. Furthermore, damage to the ball and socket joint, especially damage to the sealing bellows, with the subsequent penetration of, for example, corrosive salt water into the ball and socket joint, can be inferred, for example, from a prestressing force declining greatly within a short time in a ball and socket joint.

Against this background, the present invention pertains, furthermore, to a process for wear measurement on a ball and socket joint. The ball and socket joint comprises a sensor array, which is located in the area of the ball shell and comprises at least a pressure or force sensor for measuring the forces or pressing pressures acting between the joint ball and the ball shell.

To carry out the process for wear measurement according to the present invention on a ball and socket joint, it is first checked in a first process step whether one or more of the conditions “absence of force,” “constancy of force” or “load at standstill of the ball and socket joint,” “predetermined relative position of the ball pivot in the joint housing, which position is suitable for wear measurement” or “absence of motion of the ball and socket joint or of the motor vehicle” is present.

The more of these conditions are met, the more reliably and accurately can the subsequent measurement be carried out, and the sooner can errors of measurement as a consequence of external effects be avoided.

The value of the measured force or pressure signals of the sensor array that represent the prestressing force between the ball shell and the joint housing or between the ball shell and the joint ball is subsequently determined in another process step by means of the force sensor means of the ball and socket joint. The value of the wear of the ball and socket joint, which value corresponds thereto, is subsequently calculated in another process step from the measured signals or from the prestressing force determined.

The determined value of the wear is finally compared to a stored maximum, and a warning is sent if the maximum is exceeded.

Reliable data can thus be obtained with the process according to the present invention on the foreseeably remaining service life of the ball and socket joint. A possibly imminent failure of the ball and socket joint can also be determined or predicted thanks to the monitoring of the prestressing force or of the wear value of the ball shell according to the present invention. The reliability of operation of the ball and socket joint or of the motor vehicle equipped therewith can be decisively improved in this manner.

According to a preferred embodiment of the process for wear measurement according to the present invention, the sensor array comprises an even number of, e.g., at least two, pressure or force sensors. The pressure or force sensors are arranged in pairs opposite each other on a diameter line of the joint ball of the ball and socket joint, and the calculation of the wear value is carried out by forming the sum of the measured force or pressure signals of sensors arranged opposite each other.

The determination of the wear value on a ball and socket joint with the use of the signals of pressure or forces sensors arranged opposite each other is advantageous because a higher accuracy can thus be achieved in respect to the measurement of the prestressing force on the ball shell. Furthermore, the prestressing force can be better distinguished from other forces acting externally on the ball and socket joint as a consequence of forming the sum of the signals of sensors arranged opposite each other. This is linked with the fact that the change in a force acting externally on the ball and socket joint always causes changes in the signals of sensors arranged opposite each other in opposite directions, so that the effect of the external force is automatically eliminated during the formation of the sum of the signals of sensors arranged opposite each other and during the determination of the prestressing force, which is based on this, as well as of the value of the wear.

The use of the signals of sensors arranged opposite each other to determine the prestressing force and the value of the wear thus makes it possible to make a reliable distinction between whether measured force values are changes in the prestressing force or external forces which act on the ball and socket joint.

The present invention will be explained in more detail below on the basis of drawings showing only exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of the principle of the force breakdown for determining the total vectorial force on a ball and socket joint according to the present invention;

FIG. 2 is a schematic isometric view of an embodiment of a ball and socket joint according to the present invention;

FIG. 3 in a schematic isometric view of another embodiment of a ball and socket joint according to the present invention with representation of the total vectorial force;

FIG. 4 is a schematic view of the longitudinal section of another embodiment of a ball and socket joint according to the present invention with a capacitive force sensor;

FIG. 5 is an enlarged detail of the capacitive force sensor of the ball and socket joint according to FIG. 4;

FIG. 6 is a longitudinal section of another embodiment of a ball and socket joint according to the present invention with capacitive force sensor in a representation and view corresponding to FIG. 4; and

FIG. 7 is an enlarged view corresponding to FIG. 5 of the capacitive force sensor of the ball and socket joint according to FIG. 6.

### DESCRIPTION OF THE PREFERRED EMBODIMENTS

Referring to the drawings in particular, FIG. 1 shows the principle of the force breakdown for the determination of the total vectorial force in a highly schematic longitudinal sectional view. An idealized ball and socket joint shall be considered at first, which maintains a prestressing (prestress/precompression) force due to the manufacture under all operating conditions. In other words, the surface pressure caused by the prestressing force between the joint ball and the ball shell shall always be greater in the idealized ball and socket joint than the surface pressures brought about by operating forces, so that the joint ball will not be lifted off from the ball shell as a consequence of the effect of operating forces.

Three force or pressure sensors are already sufficient, in principle, under such idealized conditions to determine the operating force acting on the ball and socket joint in terms of both value and direction in the three-dimensional space from the signals of these three sensors. This is true if the three sensors, surrounding the joint ball, are arranged distributed in such a way that the imaginary plane spanned by the three sensors does not pass through the center of the joint ball, because a system of coordinates, whose vectors can be readily converted into vectors of a Cartesian, i.e., rectangular system of coordinates, is already defined now in the three-dimensional space by the sites of the three sensors as well as by the center of the joint ball as a reference point.

Since it can be assumed in this idealized case that the surface of the joint ball is not lifted off from the ball shell, all three sensors also yield a force component each for every imaginable operating force acting on the ball and socket joint. The operating force F can then be calculated in terms of both value and direction by vectorial addition from these three force components.

However, eight sensors rather than only three pressure or force sensors are preferably used for several reasons for the reliable and accurate measurement of the vectorial operating force F.

On the one hand, a higher accuracy of measurement can already be achieved, in principle, with a greater number of sensors, because inevitable static errors of measurement are evened out in this manner. On the other hand, it must also be expected that the idealization, according to which the joint ball is always in contact with the ball shell, does not always coincide with the conditions occurring in practice. Thus, it is realistic to assume that operating forces that are so strong that the surface pressure present between the ball shell and the joint ball is overcome because of the prestress of the ball and socket joint can definitely occur. The joint ball is lifted off from the ball shell in this case in some areas, as a result of which sensors arranged in that area no longer yield usable measured signals.

While four sensors arranged at the corners of a tetrahedron inscribed in the sensor spherical surface would theoretically already be sufficient to determine the operating force F in terms of both value and direction even in the case in which the ball surface is lifted off from the joint ball in some areas, it proved to be practicable to use not only four but eight pressure or forces sensors for the vectorial determination of the operating force F.

Namely, these eight sensors can be positioned better, on the one hand, in light of the actual geometric conditions of the joint housing and the ball shell than a tetrahedral array on the ball shell. On the other hand, as was described, a considerably higher accuracy of measurement is achieved with eight sensors than with four sensors, and, finally, the eight sensors can be arranged distributed in such a way that a simplified conversion of the measured signals into a force vector is obtained in the Cartesian system of coordinates.

If the operating force becomes so strong that the joint ball is lifted off from the ball shell in some areas, the four sensors that yield the strongest measured signal, i.e., the sensors on which the strongest force acts, are preferably used to calculate the force vector.

The principle of the determination of the force vector of the operating force F will be described at first based on the example of the two-dimensional case for the better understanding of the principle of the determination of the force vector.

FIG. 1 shows the two-dimensional analogy to a ball and socket joint with a joint ball 1, a ball shell 2 and a joint housing 3. Four pressure or force sensors S_{OL}, S_{OR}, S_{UR} and S_{UL} are arranged here between the ball shell 2 and the joint housing 3. The forces or surface pressures F_{SOL}, F_{SOR}, F_{SUR} and F_{SUL} act on the four sensors S_{OL}, S_{OR}, S_{UR} and S_{UL}.

To illustrate the force breakdown, on which the determination of the force vector F on the basis of the forces S_{OL}, S_{OR}, S_{UR} and S_{UL} measured by the sensor is based, the introduced force vector F is broken down at first into a force component F_{⊥} perpendicular to the longitudinal axis of the ball pivot as well as a force component F_{∥} parallel to the ball pivot.

The two force components F_{⊥} and F_{∥}, which do not mutually affect each other and are superimposed to one another, generate, all in all in respect to the individual sensors S_{OL}, S_{OR}, S_{UR} and S_{UL}, the forces or surface pressures F_{SOL}, F_{SOR}, F_{SUR} and F_{SUL}, whose components, which go back to the two force components F_{⊥} and F_{∥} and are thus to be added, are still shown separately in FIG. 1 for the sake of better recognizability. The force components or surface pressures acting on the sensors are always at right angles to the sensor surface, because tangential forces are not registered by the sensors or cannot be transmitted because the joint ball is in sliding contact with the ball shell.

Strictly speaking, the total force F that is introduced into the ball is not, however, distributed among the forces sensors, because a large part of the force F is absorbed by the surface of the ball shell outside the area of the sensors. The force F thus represents only the total resulting force of the partial forces actually transmitted in the area of the sensors between the joint ball and the ball shell in the example being shown in FIG. 1. However, this does not compromise the determination of the operating force F actually acting on the ball and socket joint, because the value of the actually acting force F is always proportional to the resultant of the sensor forces. However, such a proportionality factor is determined within the framework of the calibration of the sensor anyway and is thus taken into account.

The force breakdown in the area of the sensors is shown in FIG. 1 for the two lower sensors S_{UR} and S_{UL} only. However, the same force breakdown applies, in principle, to the two upper sensors S_{OR} and S_{OL} as well.

The two force components F_{⊥} and F_{∥} are distributed uniformly between the sensors S_{UL} and S_{UR} considered more specifically in FIG. 1, so that the force components acting on the sensors are always set, for the sake of simpler understandability, at half of the value of the two force components F_{⊥} and F_{∥}. However, as was already explained above, the absolute value of the conversion factor between the force components at the sensor and the components F_{Γ} and F_{∥} of the actually acting operating force F, which conversion factor is set at ½ here, play at first no role, at any rate for the purpose of the representation of the force breakdown, because the actual value of the conversion factor is set anyway only within the framework of the sensor calibration.

The force acting on the respective sensors comprises, in principle, three components. These three components are
i. the prestressing force F_{V}, which acts permanently and essentially constantly in parallel to the normals to the sensors after the manufacture of the ball and socket joint (or after the housing cover is rolled onto the joint housing);
ii. a proportional part (set at F_{∥}/2 here) of the component F_{∥} of the total force F, which component is parallel to the ball pivot; and
iii. a proportional part (set at F_{⊥}/2 here) of the component F_{⊥} of the total force F, which component is at right angles to the ball pivot.
   Consequently, the two total forces F_{SUL} and F_{SUR} on the two sensors S_{UL} and S_{UR}, which are the lower sensors in the drawing, are obtained at first with the angle α between the axis of the ball pivot and the sensor force directed at right angles to the sensor, which angle is derived from the positioning of the respective sensor at the ball and socket joint, as follows:

$${F}_{SUL} = {F}_{V} + \frac{{F}_{\vert}}{2} cos α - \frac{{F}_{⊥}}{2} sin α$$

$${F}_{SUR} = {F}_{V} + \frac{{F}_{\vert}}{2} cos α + \frac{{F}_{⊥}}{2} sin α$$

The two sensor forces S_{SOL}, and F_{SOR} for the two sensors S_{OL} and S_{OR}, which are the upper sensors in the drawing, are obtained analogously:

$${F}_{SOL} = {F}_{V} - \frac{{F}_{\vert \vert}}{2} cos α - \frac{{F}_{⊥}}{2} sin α$$

$${F}_{SOR} = {F}_{V} - \frac{{F}_{\vert}}{2} cos α + \frac{{F}_{⊥}}{2} sin α$$

By adding or subtracting the above equations as well as subsequent resolution according to the force components F_{⊥} and F_{∥}, the components F_{⊥} and F_{∥} of the total force F, which components are parallel or at right angles to the ball pivot, can already be subsequently determined from the forces measured by the sensors as follows:

$${F}_{SUL} = {F}_{V} + \frac{{F}_{\vert \vert}}{2} cos α - \frac{{F}_{⊥}}{2} sin α$$

$${F}_{SUR} = {F}_{V} + \frac{{F}_{\vert \vert}}{2} cos α + \frac{{F}_{⊥}}{2} sin α$$

The upper sign pertains to the upper sensors S_{OL} and S_{OR} and the lower sign to the lower sensors S_{UL} and S_{UR}.

To determine the angle β between the direction of action of the total force F and the longitudinal axis of the ball pivot,

F_{⊥}=F sin β

F_{∥}=F cos β

is set according to FIG. 1.

If these two equations are divided by each other and the terms determined last for the two components F_{⊥} and F_{∥} of the total force F are introduced at the same time,

$$\frac{sin β}{cos β} = ∓ \frac{cos α}{sin α} \frac{{F}_{SOR \text{/} SUR} - {F}_{SOL \text{/} SUL}}{{F}_{SOR \text{/} SUR} + {F}_{SOL \text{/} SUL} - 2 {F}_{V}}$$

is obtained. The angle β between the direction of action of the total force F and the longitudinal axis of the ball pivot is obtained from this as follows:

$$β = {tan}^{- 1} [ ∓ \frac{1}{tan α} \frac{{F}_{SOR \text{/} SUR} - {F}_{SOL \text{/} SUL}}{{F}_{SOR \text{/} SUR} + {F}_{SOL \text{/} SUL} - 2 {F}_{V}} ]$$

The value of the total vectorial force F can finally be determined as:

F=\sqrt{F_{⊥}²+F_{∥}²}

The total vectorial force F is thus known in terms of both its value and its direction on the basis of the forces measured by the sensors.

However, the prestressing force F_{V} of the ball and socket joint can additionally also be determined from the forces measured by the sensors. The forces measured by the sensors located diagonally opposite each other, i.e., F_{SOL} and F_{SUR} or F_{SOR} and F_{SUL}, are added up for this, from which double the prestressing force F_{V} is obtained. From this follows

$$\frac{{F}_{SOL} + {F}_{SUR}}{2} = \frac{{F}_{SUL} + {F}_{SOR}}{2} = {F}_{V}$$

for the value of the prestressing force F_{V}.

Since the value of the prestressing force, which decreases over time, depends primarily on the wear of the ball and socket joint, data on the current state of wear of the ball and socket joint can also be obtained, on the basis of the prestressing force F_{V} determined, at any time with the sensor array being shown, besides the vectorial operating force F.

The prestressing force can be determined reliably only as long as the joint ball has not been lifted off from the ball shell in some areas due to an operating force F introduced from the outside. To ensure contact between the joint ball and the ball shell over the entire area, the measurement of the prestressing force or of the wear of the joint is carried out only when certain boundary conditions are present, for example, always at the torque at which the engine of the motor vehicle is started, or whenever the measured velocity of the vehicle equals zero.

To make it also possible to determine the component of the total vectorial force F extending in the third dimension of space, on the basis of the force breakdown shown in FIG. 1 for the case of the two-dimensional analogy for the sake of better recognizability, not only the four sensors according to the view in FIG. 1 are used, but, as was already explained above, a total of eight pressure or force sensors are used.

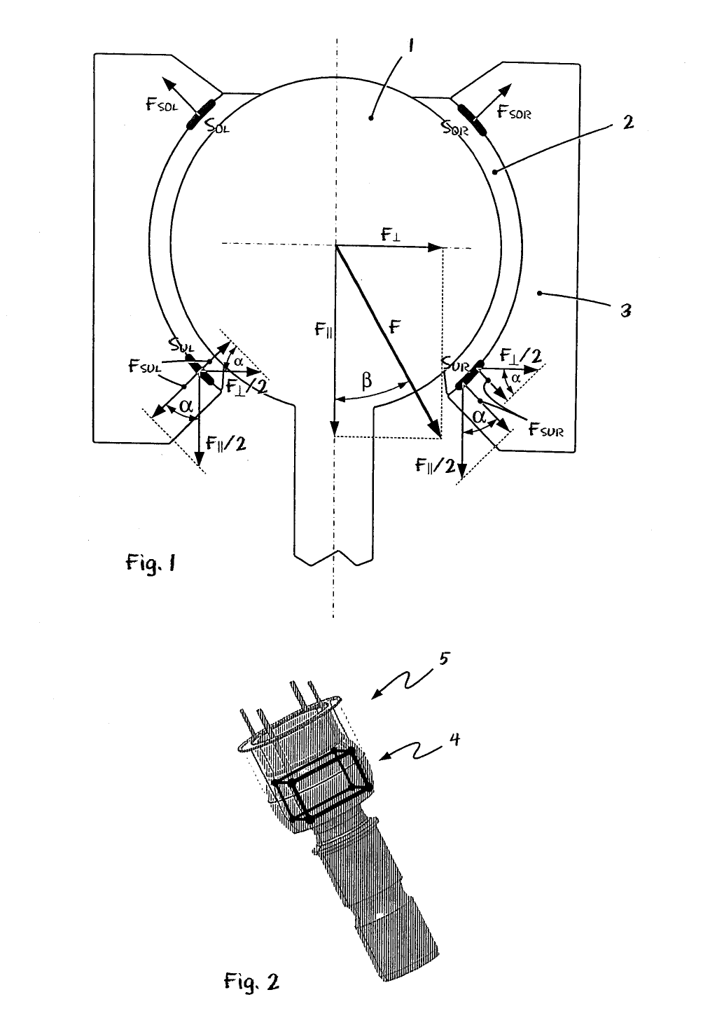

An example of the array of the eight sensors is schematically shown in FIG. 2. It can be seen that the eight sensors are arranged at the corners of an imaginary square column, i.e., of a cuboid with a square base, the square column being inscribed in an imaginary sensor spherical surface (not shown) that is concentric to the joint ball, and the vertical axis of the square column coinciding with the longitudinal axis of the ball pivot. A uniform accuracy of measurement is thus obtained for the resultants from the sensor signals for all directions in space, and both the value and the direction of the total vectorial force can be determined in the three-dimensional space by means of comparatively simple trigonometric calculations.

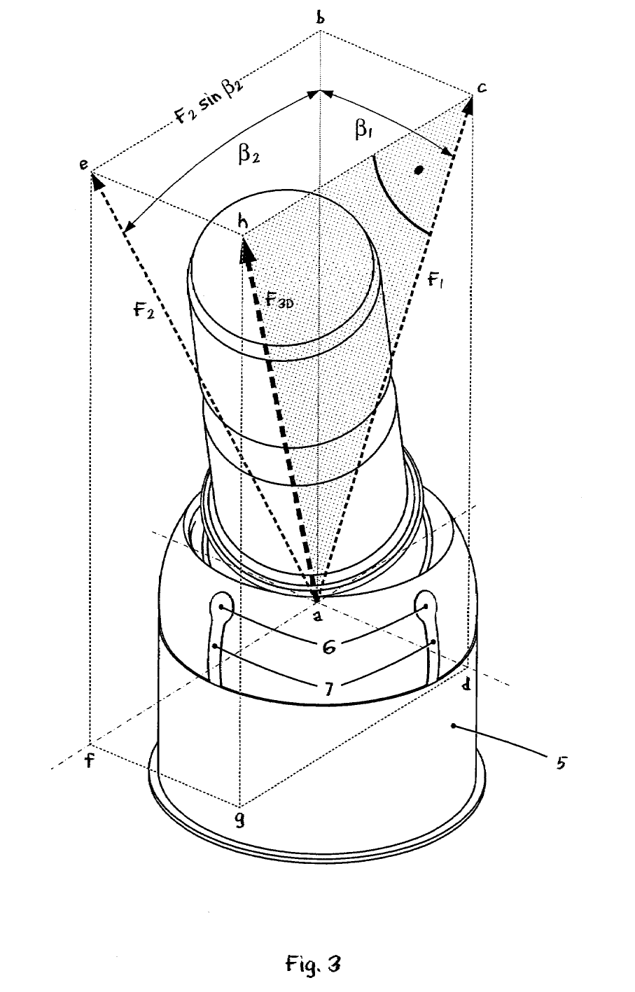

Viewing FIG. 1 and FIG. 3 together shows that the trigonometric relationships are fully analogous to the two-dimensional example according to FIG. 1 in the three-dimensional case according to FIGS. 2 and 3. The force breakdown according to FIG. 1 is to be performed separately for the three-dimensional case only twice for the two section planes abcd and abef for the four sensors each contained in them and for the force components F₁ and F₂, cf. FIG. 3. Finally, only the resultant F_{3D} must be formed from the two force components F₁ and F₂ according to the view in FIG. 3.

The rectangular triangle ahc (dotted line, with right angle at c) inscribed in the imaginary cuboid abcdefgh defined by the two force components F₁ and F₂ can be used to determine the value of the total resulting force F_{3D}. According to Pythagoras,

F_{3D}=\sqrt{F₁²+ h̅c̅²̅}

is true here.

With the other trigonometric relationship

h̅c̅= e̅b̅=F₂ sin β₂

the value of the total force F_{3D} in the three-dimensional space is thus obtained as follows:

F_{3D}=\sqrt{F₁²+F₂² sin² β₂}

Both the direction and the length of the force vector F_{3D} is again determined unambiguously for the three-dimensional case by the value of the force F_{3D} thus determined as well as by the two angles β₁ and β₂.

Besides the representation of the force breakdown, FIG. 3 also shows the arrangement of two of the total of eight pressure or force sensors 6 with the respective feed lines 7 belonging to them. The six other sensors are not visible in the view in FIG. 3, because they are either in the background of the drawing or are hidden by a component 5 of the joint housing or of the joint housing cover.

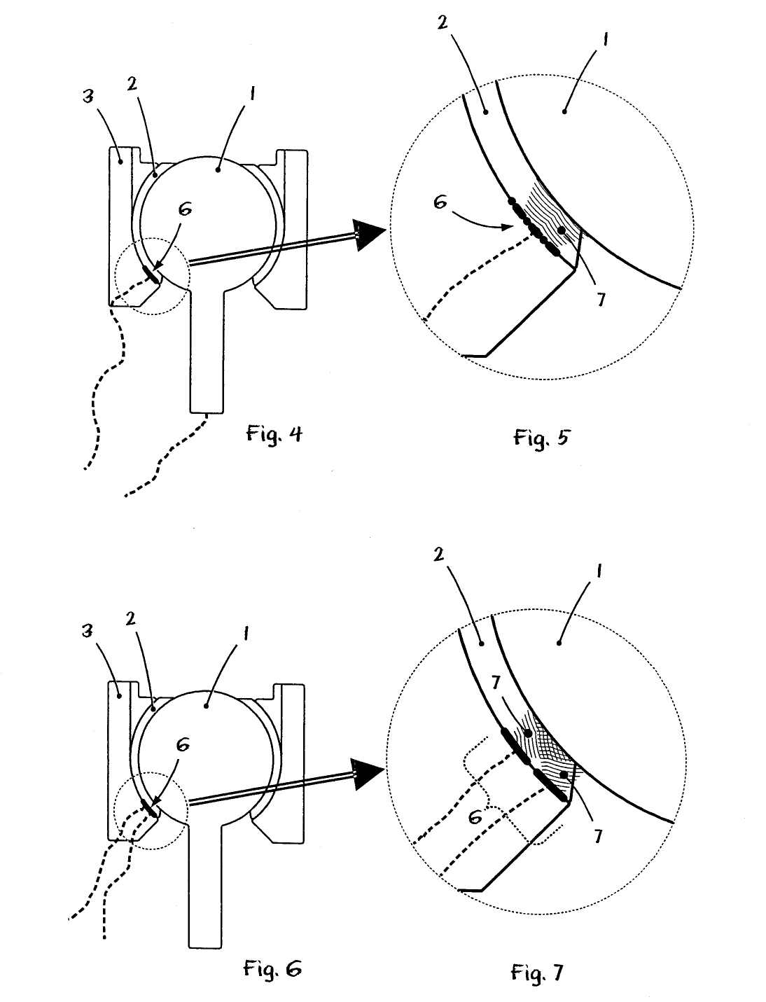

FIGS. 4 through 7 show embodiments of a ball and socket joint according to the present invention with capacitive pressure or force sensors in a highly schematic longitudinal section. The view in FIGS. 4 and 5 pertains to a capacitive sensor 6, in which one pole is formed by an electrode arranged on the outer side of the ball shell 2, while the joint ball 1 forms the opposite electric pole.

The principle of action of the capacitive sensor 6 is that a capacitor 7, whose capacitance changes with any change in the distance between the electrode of the sensor 6 and the joint ball 1, is formed by the electrode of the sensor 6, which electrode is arranged in the area of the ball shell 2, together with the joint ball 1, which is electrically insulated from that electrode by the material of the ball shell 2.

FIGS. 6 and 7 likewise show a capacitive sensor 6, which is designed, however, in the form of two capacitors 7 connected in series. The two series-connected capacitors 7 are formed, together with the joint ball 1, which is free from potential in this case, as an intermediate electrode common to both capacitors 7, by two electrodes arranged on the outer side of the ball shell 2.

The capacitive sensor 6 according to FIGS. 6 and 7 thus has the great additional advantage that unlike in the sensor according to FIGS. 4 and 5, contacting of the joint ball 1 or of the ball pivot is no longer necessary in this sensor. Rather, only the two feed lines to the two electrodes of the sensor 6, which electrodes are arranged adjacent to each other, are to be laid.

The use of capacitive sensors of such a design is advantageous in terms of a simple, robust design and trouble-free operation of the ball and socket joint. Since the elastic changes in the wall thickness of the ball shell 2 are extensively proportional to the surface pressure acting between the joint ball 1 and the ball shell 2, the surface pressure present locally can be inferred directly and exactly by measuring the capacitance of the sensor.

Further advantages of such capacitive sensors are especially that such sensors operate practically without wear, make do with a simple analysis circuit and have a lower power consumption.

Thus, it becomes clear as a result that thanks to the present invention, ball and socket joints or processes for load measurement and for wear measurement on ball and socket joints are provided, with which extremely accurate and reliable determination of the operating state and load state or of the wear of the ball and socket joint is made possible. The present invention makes possible the vectorial determination of forces or of loads acting on the ball and socket joint in a robust and reliable manner. Furthermore, exact data can be obtained on the state of wear of the ball and socket joint, so that an imminent failure of the ball and socket joint can be recognized in time and prevented.

Thus, the present invention makes a fundamental contribution to the improvement of safety, reliability and failure prevention in ball and socket joints as well as to the expansion of the data base of driver assistance systems, especially where ball and socket joints are used in the area of demanding axle systems and wheel suspensions on the motor vehicle.

While specific embodiments of the invention have been shown and described in detail to illustrate the application of the principles of the invention, it will be understood that the invention may be embodied otherwise without departing from such principles.

1-14. (canceled)

15. A motor vehicle system ball and socket joint comprising:
a joint housing defining an interior space;
a ball shell arranged in said interior space of said joint housing;
a ball pivot with a ball accommodated in said ball shell in a slidingly movable manner;
a sensor means for measuring forces or loads, said sensor means being formed by a sensor array placed in an area of said ball shell, said sensor array comprising at least two pressure or force sensors for measuring forces or pressing pressures acting between said joint ball and said ball shell.

16. A motor vehicle system ball and socket joint in accordance with claim 15, wherein said at least two pressure or force sensors comprises three pressure or force sensors for measuring the forces or pressing pressures acting between said joint ball and said ball shell, wherein said three pressure or force sensors are arranged essentially on an imaginary sensor spherical surface that is concentric to said joint ball such that the plane spanned by said sensors does not pass through the center of the sensor spherical surface.

17. A motor vehicle system ball and socket joint in accordance with claim 15, wherein said at least two pressure or force sensors comprises eight pressure or force sensors arranged on an imaginary sensor spherical surface that is concentric to said joint ball, said eight pressure or force sensors being arranged on at least two different great circles of said sensor spherical surface.

18. A motor vehicle system ball and socket joint in accordance with claim 17, wherein said eight sensors are arranges at the corner points of an imaginary square column inscribed in said sensor spherical surface, the vertical axis of said square column coinciding with the longitudinal axis of said ball pivot.

19. A motor vehicle system ball and socket joint in accordance with claim 15, wherein said at least two pressure or force sensors comprises wire strain gauges.

20. A motor vehicle system ball and socket joint in accordance with claim 15, wherein said at least two pressure or force sensors comprises piezo sensors.

21. A motor vehicle system ball and socket joint in accordance with claim 15, wherein said at least two pressure or force sensors comprises capacitive sensors.

22. A motor vehicle system ball and socket joint in accordance with claim 21, wherein said capacitive sensor comprises and electrode arranged in said ball shell or an outer side of said ball shell, and a counterelectrode formed by said joint ball.

23. A motor vehicle system ball and socket joint in accordance with claim 21, wherein said capacitive sensor comprising two capacitors connected in series, said sensor joint ball being potential-free and cooperating with two electrodes arranged adjacent to each other in said ball shell or on the outer side of said ball shell to form said two capacitors.

24. A process for measuring the load of a ball and socket joint, the process comprising the steps of:
providing a joint housing defining an interior space;
providing a ball shell arranged in said interior space of said joint housing;
providing a ball pivot with a ball accommodated in said ball shell in a slidingly movable manner;
providing a sensor means for measuring forces or loads, said sensor means being formed by a sensor array placed in an area of said ball shell, said sensor array comprising at least two pressure or force sensors for measuring forces or pressing pressures acting between said joint ball and said ball shell;
determining the force or pressure signals of said sensors;
calculating local pressures or forces from the measured signals of said sensors; and
forming a force vector resulting from the local pressures or forces.

25. A process for load measurement in accordance with claim 24, wherein a prestressing force between said ball shell and said joint ball is calculated in said step of forming a force vector.

26. A process for load measurement in accordance with claim 25, wherein the calculation of the prestressing force between said ball shell and said joint ball is carried out by forming the sum of the signals of said sensors located opposite each other.

27. A process for wear measurement on a ball and socket joint, the process comprising the steps of:
providing a joint housing defining an interior space;
providing a ball shell arranged in said interior space of said joint housing;
providing a ball pivot with a ball accommodated in said ball shell in a slidingly movable manner;
providing a sensor means for measuring forces or loads, said sensor means being formed by a sensor array placed in an area of said ball shell, said sensor array comprising at least two pressure or force sensors for measuring forces or pressing pressures acting between said joint ball and said ball shell;
determining the force or pressure signals of said said sensor array;
calculating local pressures or forces from the measured signals of said sensors;
based on the calculated local pressures or forces checking whether one or more of the conditions absence of forces or constancy of forces, a certain relative position of the ball pivot and joint housing or absence of motion is met;
calculating a wear value from the measured signals;
comparing the wear value with a maximum wear value and sending an alarm in a case of exceeding a maximum wear value.

28. A process for wear measurement in accordance with claim 27, wherein the sensor array comprises an even number of said pressure or force sensors, which are arranged opposite each other in pairs on a diameter line of said joint ball; and
said calculating a wear value is carried out by forming the sum of the measured force Or pressure signals of said sensors located opposite each other.
